(19) United States
(12) Patent Application Publication
(10) Pub. No.: US 2009/0288343 A1
(43) Pub. Date: Nov. 26, 2009

(54) CLOSING SYSTEM FOR REFRIGERATING CABINETS

(75) Inventor: Rossi Romolo, Bastia Umbra (PG) (IT)

Correspondence Address: YOUNG & THOMPSON, 209 Madison Street, Suite 500, ALEXANDRIA, VA, 22314, US

(73) Assignee: INDUSTRIE SCAFFALATURE ARREDAMENTI ISA S.P.A., Bastia Umbra (PG) (IT)

(21) Appl. No.: 12/328,150

(22) Filed: Dec. 4, 2008

(30) Foreign Application Priority Data
May 26, 2008 (IT) RM2008A000277

(51) Int. Cl. E06B 5/00

(52) U.S. Cl. 49/77.1

(57) ABSTRACT

A closing system for refrigeration cabinets comprises a plurality of panels mutually connected two by two and movable along a direction of actuation, between a first position of opening of a compartment of a refrigeration cabinet, whereat the panels are in compact configuration, mutually superposed and laying on planes that are transverse to said direction of actuation, and a second position of closing of the compartment, whereat the panels are in extended configuration, distributed along the direction of actuation. The closing system also comprises at least one element for supporting and guiding the panels and at least one traction device of the panels, to allow their actuation. The closing system can be coupled to each compartment constituting the refrigerating cabinet, to reversibly close access to the products contained within the compartment.

### BACKGROUND OF THE INVENTION

The present invention relates to a closing system for refrigerating cabinets.

In particular, the present invention is applicable to the individual containment compartments of the refrigerating cabinets containing refrigerated food products. As is well known, in food stores some products are exhibited on shelves or inside refrigerating cabinets.

Generally, frozen products are contained in compartments with tanks or shelves, the latter always closed by sealing doors which the user opens when it is required to do so; refrigerating cabinets for refrigerated products can also be tank shaped or with shelves, but they are generally always open, with consequent high energy consumption. To reduce energy consumption, in some stores the refrigerated compartments are also provided with closing systems, active at least during non-working hours.

Closing systems, i.e. systems that introduce a more or less continuous and sizeable barrier on the ideal surface that constitutes the opening of the cabinet to the environment with the goal of reducing thermal dispersions and improve the preservation of the product, can be classified in two types: night-time closings and day-time closings.

Night-time closing systems are very effective from the thermal point of view, are completely covering and are applied manually, often in inconvenient fashion for service personnel, or in motorized fashion, with actuation times of some tens of seconds.

Once they are removed, these closing systems have to be removed from the cabinet or anyway they cannot remain in view because they would hamper accessibility to the products, as well as being aesthetically displeasing.

Day-time closing systems, instead, are used during sales hours, but they can easily be used also during off hours, alternatively to or with the aid of night-time closing systems. Generally, these systems arc see-through, to allow buyers to view the product. They are less effective from the thermal viewpoint than night-time closing systems and they are removed manually by final users to access the product to be withdrawn. Once removed, these systems remain visible near the compartment, oftentimes also in positions that hinder access to neighbouring compartment and/or that limit the physical approach to the cabinet.

Currently, there is no solution that combines the advantages of day-time closing, i.e. the good visibility of the product and the possibility of a continuous access to the compartment, with those of night-time closing, i.e. to remain out of sight and not to hinder accessibility to the product and to the cabinet when they are open.

### SUMMARY OF THE INVENTION

In particular, an object of the present invention is to solve the problems noted in the prior art, proposing a closing system for refrigerating cabinets able to overcome the aforementioned drawbacks. In particular, an object of the present invention is to provide a closing system for refrigerating cabinets that allows good visibility and accessibility to the products contained in the different compartments, without hindering access to neighbouring compartments during the opening and/or closing phases.

Therefore, an object of the present invention is to propose a closing system for refrigerating cabinets that has reduced size but still enables to reduce energy consumption.

Another object of the present invention is to propose a system for closing refrigerating cabinets that is modular and adaptable according to the requirements of space and arrangement of each refrigerating cabinet.

These objects and others as well, which shall become more readily apparent in the course of the following description, are substantially achieved by a closing system for refrigerating cabinets comprising the characteristics expressed in one or more of the appended claims.

### BRIEF DESCRIPTION OF THE DRAWINGS

Further characteristics and advantages shall become more readily apparent from the detailed description of a preferred, but not exclusive, embodiment of a closing system for refrigerating cabinets in accordance with the present invention. Said description shall be provided below with reference to the accompanying figures, provided purely by way of non limiting indication, in which:

FIG. 1 shows a lateral section view of a refrigerating cabinet comprising a closing system in accordance with the present invention, in a first operative position;

FIG. 2 shows a lateral section view of a refrigerating cabinet comprising a closing system in accordance with the present invention, in a second operative position;

FIG. 3 shows a lateral view of the closing system of the present invention in the first operative position;

FIG. 4 shows a lateral view of the closing system of the present invention in the second position;

FIG. 5 shows a sectioned plan view of a detail of the closing system of the present invention;

FIG. 6 shows a partially sectioned perspective view of the closing system of the present invention in the first operative position;

FIG. 7 shows a partially sectioned perspective view of the closing system of the present invention in the second operative position.

### DESCRIPTION OF THE PREFERRED EMBODIMENT

With reference to the accompanying figures, the number 1 indicates, in its entirety, a closing system for refrigerating cabinets 2 in accordance with the present invention.

The refrigerating cabinets 2 comprise a plurality of compartments 3 for the containment of food products to be sold. The closing system 1 of the present invention is able to be associated with at least one compartment 3 of a refrigerating cabinet 2, preferably with each compartment 3, to close reversibly access to the products contained within the compartment 3 with which it is associated.

The closing system 1 comprises a plurality of panels 5 connected to each other to define a protective screen 20, able to close the containment compartment 3.

In particular, said panels 5 are mutually connected two by two, preferably hinged to each other, and they are movable along a direction of actuation S between a first open position and a second closed position of the respective compartment 3.

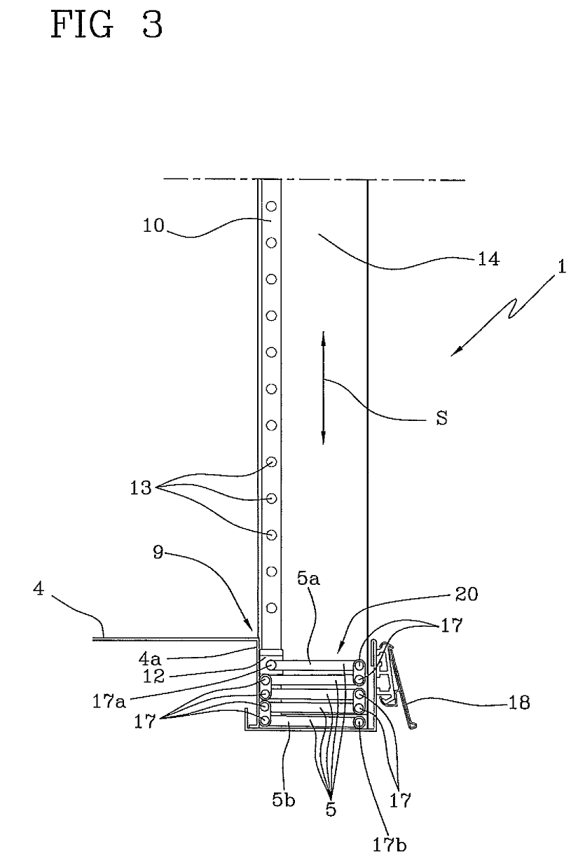

FIG. 3 shows the panels 5 placed in the first open position of the compartment 3, whereat the panels 5 are in a compact configuration, mutually superposed on each other and lying on planes preferably transverse to the direction of actuation S.

In this configuration, therefore, the protective screen 20 is closed, folded on itself, in such a way as to allow for a free access to the compartment 3 and to the products positioned on the shelf 4 of said compartment 3.

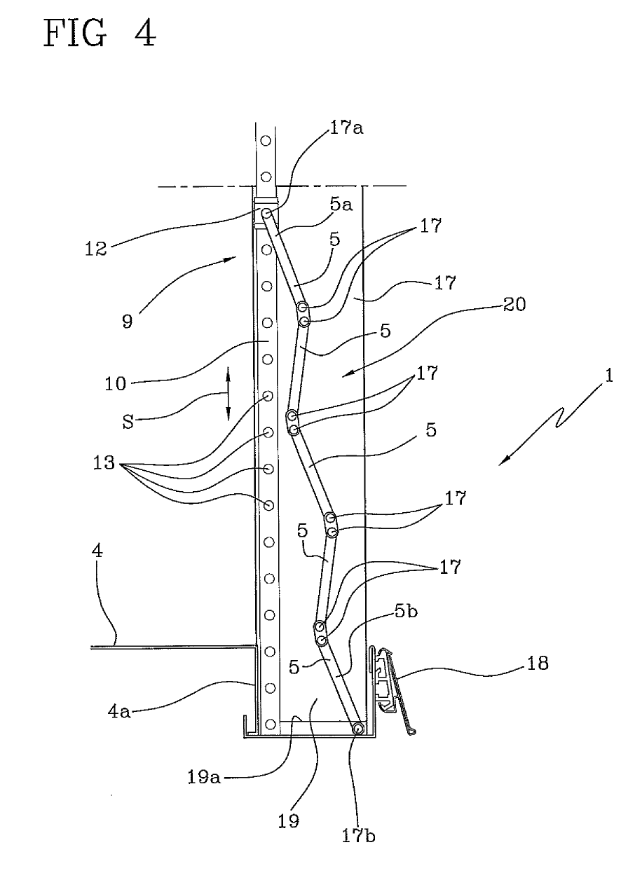

FIG. 4, instead, shows the panels 5 in the aforementioned second closed position of the compartment 3, whereat the panels are positioned in an extended configuration, distributed along the direction of actuation S.

In this configuration, the protective screen 20 is extended, open in bellows fashion, to close the compartment 3. The panels 5 are thus connected to each other, preferably hinged, in such a way as to open in bellows fashion to move from the first to the second position. The panels 5 are actuated by means of a traction device 9, active on a first driving panel 5a of the screen 20 that drives the other panels 5 in the translating motion.

The panels 5 have preferably quadrilateral shape and they comprise two opposite sliding sides 6 and two opposite sides 7 of connection between the panels.

Advantageously, the panels 5 are in a variable number, depending on the amplitude of the compartment to be closed: in the example illustrated, they are five.

The sliding sides 6 define, in their entirety, two opposite sliding sides 20a of the protective screen 20.

Each panel 5 is at least partially framed in a covering profile 8 which, preferably, covers at least the two opposite sliding sides 6 of the panels 5 and at least partially the two coupling sides 7 of the panels 5.

Advantageously, two adjacent panels 5 are connected in respective hinge points 17 positioned at the covering profile 8.

Said profile 8 could be, in particular embodiments, an integral part of the panel 5. Hereafter, nonetheless, reference shall be made to the solution described above, of a profile 8 separate from the panel 5.

The closing system 1 also comprises at least one traction device 9 of the panels to actuate the protective screen 20. The driving panel 5a is operatively connected to the traction device 9 and it drags the remaining panels 5 along the direction of actuation S, thereby to actuate the protective screen 20 from the first to the second position and vice versa.

The traction device 9 comprises at least one traction device 9 comprises at least one driving bar 10 movable along the direction of actuation S and it is associated at least with the driving panel 5a, to raise and lower the panels respectively to close and open the compartment 3.

In particular, the driving bar 10 is parallel to the direction of sliding S of the panels 5 and it is actuated, preferably, by a motor 11 positioned above or within the refrigerating cabinet 2.

Moreover, the traction device 9 also comprises a towing block 12 associated to the driving bar 10 and connected to the driving panel 5a: the towing block 12, translating rigidly with the bar 10, drags along the direction of actuation S the driving panel 5a which, in turn, promotes the lifting of the remaining panels 5.

The towing block 12 is preferably coupled to the driving panel 5a at the covering profile 8, in such a way as to allow both the bearing and the lifting of the driving panel 5a and the relative rotation thereof with respect to the towing block 12.

Aligned axially along the longitudinal development of the driving bar 10, a plurality of holes 13 are provided, whereat can be fastened, in adjustable position, the towing block 12.

The position of attachments of each towing block 12 depends on the distance between two consecutive shelves 4, delimiting a single containment compartment along the direction of translation of the panels 5.

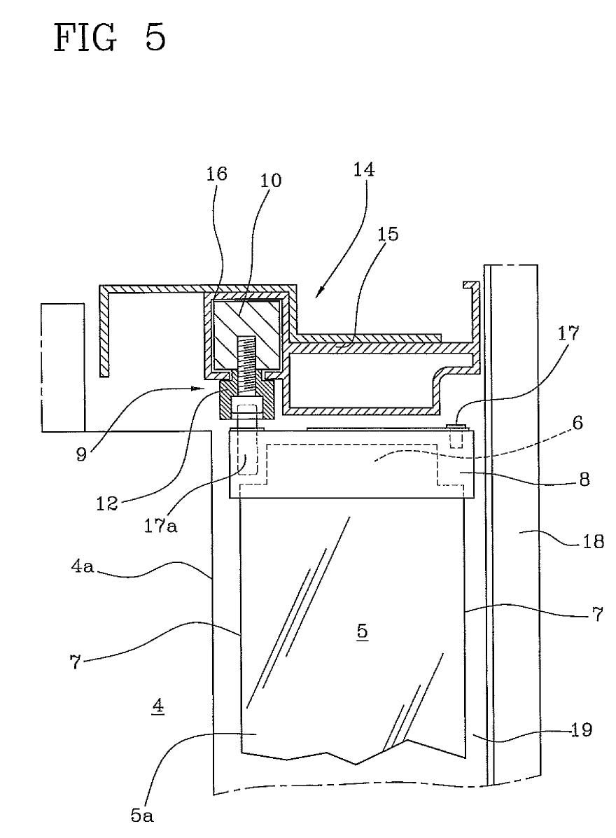

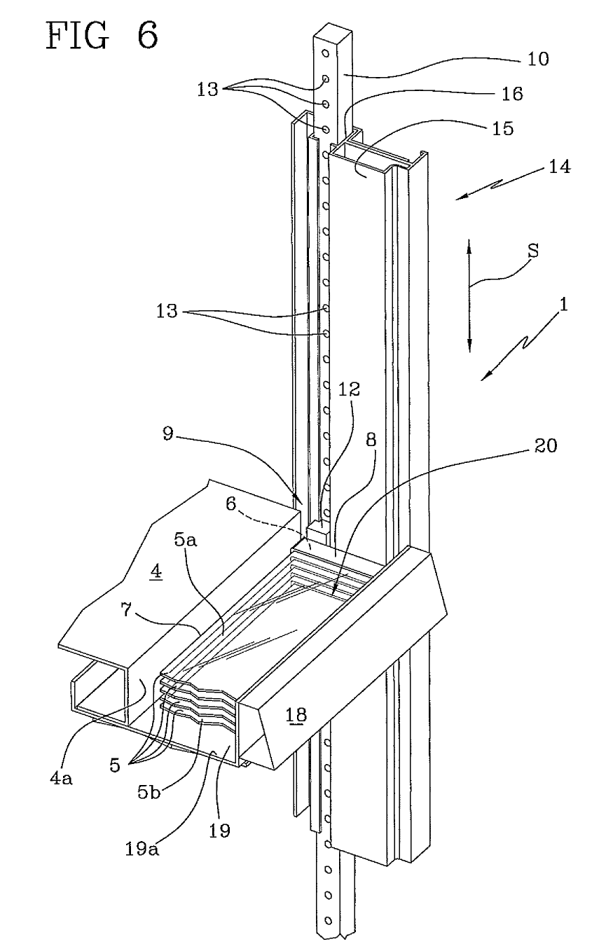

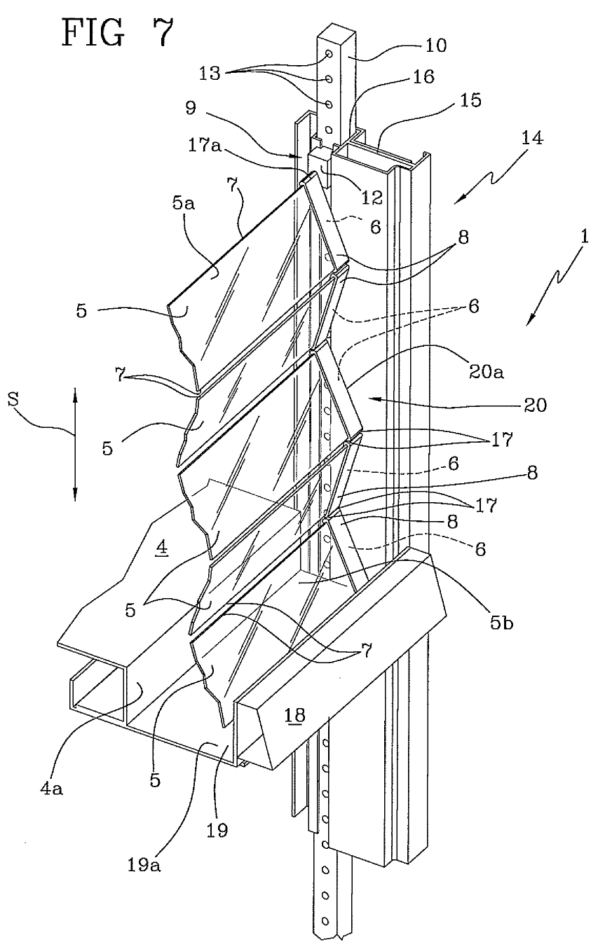

As shown in FIGS. 6 and 7, the closing system 1 further comprises at least one support and guide element 14 for the panels 5, operatively associated both to the sliding sides 6 of the panels 5 and to the traction device 9. Preferably, there are two support and guide elements 14, obviously symmetrical, one for each sliding side 6 of the panels 5. As better shown in FIG. 5, the support and guide element 14 comprises a section bar 15 comprising at least one sliding seat 16, able to contain the traction device 9, and in particular the driving bar 10. Advantageously, the better to balance and support the weight of the panels 5, there are two traction devices 9, both active on the same driving panel 5a: the two devices are fastened to two driving bars 10 with synchronous motion, in turn associated to a respective support and guide element 14. The protective screen 20 comprises a tail panel 5b at the opposite end relative to the driving panel 5a.

At the first operative position, i.e. in the open configuration of the compartment, the panels 5 can be housed, fully or partially, in a seat 19 positioned anteriorly to the shelf 4, between a front edge 4a of the shelf 4 and a front element 18 of the shelf 4, typically the price tag support.

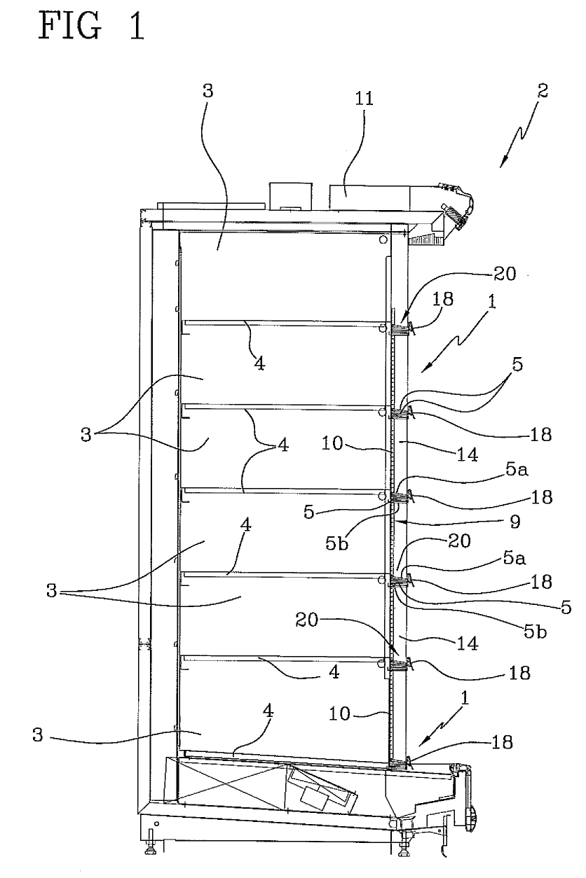

In this configuration, the screen 20 is folded on itself and the panels are therefore positioned on each other, substantially in horizontal position, or otherwise transverse, relative to the direction of actuation S, as shown in FIGS. 1 and 3. In this configuration, the panels 5 are at least partially hidden behind the front element 18 of the related shelf, to allow complete visibility of the products and enable to access the compartment 3.

The tail panel 5b is fastened to the base 19a of the housing seat 19, it is preferably hinged thereto, as shown in FIG. 4, in such a way as to assure a correct actuation of the panels 5 from the first to the second position and vice versa.

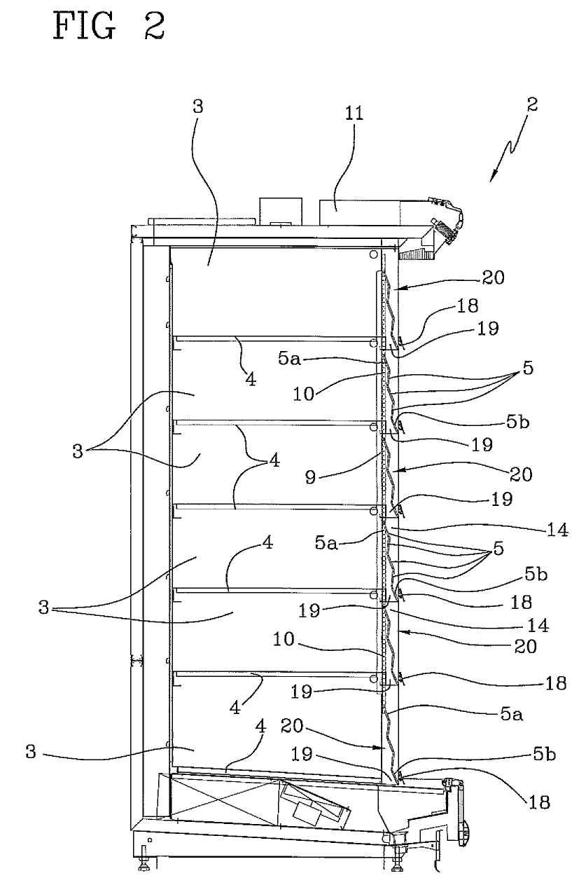

The accompanying FIGS. 1 and 2 show examples of vertical refrigerating cabinets. In this configuration, the panels 5 slide on vertical planes, in vertical direction, i.e. in the direction of the height of the cabinet 2; in the case of semi-vertical cabinets, where the ideal plane that separates the refrigerated volume from the outside environment is not orthogonal to the floor but inclined (because for example the shelves 4 that delimit the compartments 3 have depth that is progressively decreasing from the base to the top of the cabinet), the panels 5 slide on oblique planes, inclined relative to the horizontal, i.e. relative to the bearing plane of the cabinet itself.

The accompanying figures show the preferred configuration of the closing system 1 with panels able to slide on a substantially vertical plane. Specifically, the screen 20 is preferably positioned along a substantially diagonal, since, to allow a correct actuation of the panels 5 and a correct folding of the screen 20, the fastening point 17b of the tail panel 5b with the base 19a of the seat 19 is not vertically aligned with the fastening point 17a of the driving panel 5a with the towing block 12. In other words, as shown in FIG. 4, the fastening point 17a of the driving panel 5a with the towing block 12 is positioned on the driving bar 10, whilst the fastening point 17b of the tail panel 5b with the base 19a of the seat 19 is located in a diagonally opposite position.

The closing system 1 of the present invention can be coupled individually to each compartment 3 constituting the refrigerating cabinet 2, to close, in reversible fashion, access to the products contained within and to minimize thermal dispersion to the environment. Therefore, each individual product containment compartment 3 is closed by a respective closing system 1, and in particular by a group of panels 5, defining a protective screen 20, which are lifted by the traction device 9, deploying in bellows fashion, to move from a first position in which they are mutually superposed, as shown in FIGS. 1 and 3, to a second position, as shown in FIGS. 2 and 4, in which they are positioned along the direction of actuation S, which substantially matches the height of the compartment 3.

The system also comprises a control device, not shown, able to control the opening of the panels 5. In particular, said control device can comprise, for example, position or volumetric sensors that detect the presence of a user, communicate the information to a central unit which in turn activates the motor 11 that actuates the traction bar 10 and hence, through the towing block 12, causes the opening or the closing of the panels 5.

The system is thus easily automated, e.g. with the simultaneous opening of the shelves of an entire cabinet or of a portion thereof at pre-determined times or when customers enter the isle or when a customer approaches the cabinet, as described above. Similar automatic mechanisms can be provided for the closing phase.

Alternatively, the control device can also be manual and operated directly by the user.

Both in the case of manual activation and of automated activation, when the compartment 3 is closing, the towing block 12 translates upwards and drags the driving panel 5a which, in turn, lifts the remaining panels 5 deploying them. Vice versa, during the opening of the compartment 3, the driving bar 10 causes the downwards translation of the towing block 12 which, therefore, accompanies downwards the driving panel 5a and the remaining panels 5, guided by their weight. The panels translate downwards by falling, also guided by the section bar 15, until they bear on the base 19a of the seat 19.

In this position, the panels 5 can be considered out of customers' sight.

Alternatively, a portion of the panels 5 may remain visible to serve as a product holder, because it is sufficiently low not to hide the products but sufficiently low to prevent the product from sliding down from the shelf, which is generally slightly inclined downwards. Preferably, the closing systems 1 of a same row of containment compartments are activated simultaneously. Alternatively, there may be a plurality of driving bars 10, uncoupled from each other, and actuated individually by an electric motor.

The panels 5 are made of transparent material, e.g. plastic, glass or methacrylate, in order constantly to assure the visibility of the products arranged on the shelves. Moreover, the closing system 1 is not airtight, so that there is a constant recirculation of air that prevents the panel from fogging over with the consequent temporary inhibition of the visibility of the products.

The described closing system is modular, i.e. it can be applied on all the shelves or exhibition counters of refrigerating cabinets with vertical development, with oblique development or with horizontal development and it can be adapted to the different dimensions and heights of the compartments containing the products. The holes present on the driving bar 10 enable to determine the travel of the panels according to the height separation between two consecutive shelves. Therefore, said closing system is compatible with the need to change the height position of the shelves, typical for the type of display cases described. Once the shelves are positioned at the desired height, it is sufficient to adjust the height of the various traction devices, and specifically the abutment blocks, so that in the open position the panels reach a correct height, without interfering with the overlying shelf (or ceiling); for the lower end stop, instead, no adjustment is necessary, because the panels stop in any case by gravity on the front part of the shelf, regardless of the actual maximum travel of the traction device.

Since the movements of the driving panel are relatively limited, in the order of a few centimetres, the system goes from the open position to the closed position in a short time, in the order of seconds, making it possible to automate the system.

The described closing system therefore combines the advantages of day-time closing systems with the advantages of night-time closing systems, allowing good visibility and ease of access to the products, whilst limiting energy consumption since each compartment is closed individually, both when the store is closed and, above all, when the store is open.

What is claimed:

1. A closing system for refrigerating cabinets, comprising:
a plurality of panels mutually connected two by two and movable along a direction of actuation, between a first position of opening of a compartment of a refrigeration cabinet whereat the panels are in compact configuration, mutually superposed and laying on planes that are transverse to said direction of actuation, and a second position of closing of said compartment, whereat the panels are in extended configuration, distributed along the direction of actuation;
at least one element for supporting and guiding said panels;
at least one traction device of the panels, able to actuate said panels;
said closing system can be coupled to each compartment constituting the refrigerating cabinet, to reversibly close access to the products contained within the compartment.

2. System as claimed in claim 1, wherein said panels are transparent.

3. System as claimed in claim 1, wherein said panels, mutually hinged two by two, form a single structure defining a protective bellows screen for said compartment.

4. System as claimed in claim 1, wherein said panels comprise a driving panel, operatively connected to said traction device, able to drive the remaining panels from the first to the second position.

5. System as claimed in claim 1, wherein the panels, in said first position, can be housed in a seat positioned anteriorly to a shelf of said compartment, between a front edge of said shelf and a frontal element of the shelf itself.

6. System as claimed in claim 5, wherein the panels, in said first position, are at least partially hidden behind the front element of the shelf of the respective containment compartment, to allow complete visibility of the products contained within the compartment and to allow access to said compartment.

7. System as claimed in claim 5, wherein said panels comprise a tail panel, hinged to said housing seat, such as to assure a correct folding of the panels from the second to the first position.

8. System as claimed in claim 1, wherein each panel is at least partially framed in a covering profile, which covers at least two opposite sliding sides.

9. System as claimed in claim 8, wherein said panels are mutually hinged at the respective covering profiles delimiting the opposite sliding sides.

10. System as claimed in claim 1, wherein said supporting and guiding element comprises at least one section bar, positioned at least at a first sliding side of the panels and associated to said fraction; said section bar comprising at least one sliding seat able to contain the traction device.

11. System as claimed in claim 1, wherein it comprises at least two of said supporting and guiding elements located at mutually opposite positions, each at a respective sliding side of said panels.

12. System as claimed in claim 1, wherein said traction device comprises at least one driving bar, movable along the direction of actuation of the panels.

13. System as claimed in claim 12, wherein said panels comprise a driving panel, operatively connected to said traction device, able to drive the remaining panels from the first to the second position and wherein said traction device comprises at least one towing block, associated to said driving bar and hinged to said driving panel, to drag along the direction of actuation said driving panel which, in turn, promotes the lifting of the remaining panels.

14. System as claimed in claim 13, wherein each panel is at least partially framed in a covering profile, which covers at least two opposite sliding sides and wherein said towing block is fastened to the profile delimiting at least two sliding sides of the driving panel.

15. System as claimed in claim 13, wherein said towing block is fastened to the driving bar in an adjustable position.

16. System as claimed in claim 13, wherein said driving bar comprises a plurality of holes, aligned along the longitudinal development of said bar, to adjust the attachment position of the towing block.

17. System as claimed in claim 1, wherein it comprises two traction devices, each associated, in mutually opposite position, to a respective first sliding side of a first driving panel and each operatively connected with a respective support and guide element.

18. System as claimed in claim 1, wherein said panels slide along a vertical plane.

19. System as claimed in claim 1, wherein said panels slide along an oblique plane.

20. System as claimed in claim 1, wherein it comprises at least one control device able to control the opening of said system.

21. Refrigerating cabinet comprising a plurality of compartments for the containment of food products comprising, associated to each containment compartment, a closing system as claimed in claim 1.

22. A refrigerating cabinet as claimed in claim 21, wherein the closing systems associated to the individual containment compartments are activated simultaneously.

23. A refrigerating cabinet as claimed in claim 21, wherein the closing systems associated to the individual containment compartments are activated individually.
